(19) United States
(12) Patent Application Publication
(10) Pub. No.: US 2007/0114700 A1
(43) Pub. Date: May 24, 2007

(54) Apparatus, system and method for manufacturing a plugging mask for a honeycomb substrate

(76) Inventors: Edward Francis Andrewlavage JR., Corning, NY (US); David John Worthey, Elmira, NY (US); Leon Robert Zoeller III, Hammondsport, NY (US)

Correspondence Address: CORNING INCORPORATED, SP-TI-3-1, CORNING, NY, 14831, US

(21) Appl. No.: 11/287,000

(22) Filed: Nov. 22, 2005

(51) Int. Cl. B23K 26/36; B29C 35/08

(52) U.S. Cl. 264/400; 425/174.4; 264/156

(57) ABSTRACT

A method and system for manufacturing a mask for plugging cells in a honeycomb substrate includes capturing an image of the substrate's end through an end-adhered transparent or translucent film using a camera, forming openings using a laser, wherein a working distance, WD_{C}, of the camera while capturing the image is substantially the same as a working distance, WD_{L}, of the laser while forming the openings. Also disclosed is an apparatus for manufacturing a mask on a honeycomb substrate, having a laser to form openings in a film applied to the substrate's end; and an optical system, wherein either the optical system or the substrate is moveable between first and second operating positions. In a first embodiment, the camera moves whereas in the second, the substrate moves. In each embodiment, the image is obtained without obstructing the path of the laser. Also disclosed is a system for manufacturing masks including multiple cameras and lasers wherein masks are formed on both ends of the substrate without having to reposition the substrate in a holder.

### FIELD OF THE INVENTION

The invention relates generally to a method and apparatus for manufacturing a wall-flow particulate filter and other selectively plugged honeycomb structures. More specifically, the invention relates to an apparatus, system and method for forming a mask used for plugging cells of a honeycomb substrate to form a wall-flow particulate filter.

### BACKGROUND OF THE INVENTION

Solid particulates in fluids such as exhaust gas are typically removed using wall-flow particulate filters having a generally honeycomb structure. FIG. 1 illustrates a typical wall-flow particulate filter 100 having a honeycomb structure. The honeycomb filter 100 has an inlet end face 102 and an outlet end face 104. An array of interconnecting porous walls 106 extend longitudinally from the inlet end face 102 to the outlet end face 104. The interconnecting porous walls 106 define a grid of inlet cells 108 and outlet cells 110. The outlet cells 110 are closed with plugs 112 where they adjoin the inlet end face 102 and open where they adjoin the outlet end face 104. Similarly, the inlet cells 108 are closed with plugs (not shown) where they adjoin the outlet end face 104 and open where they adjoin the inlet end face 102. Fluid, such as exhaust gas, directed at the inlet end face 102 of the honeycomb filter 100 enters the inlet cells 108, flows through the interconnecting porous walls 106 into the outlet cells 110, and exits the honeycomb filter 100 at the outlet end face 104.

In a typical cell structure, each inlet cell 108 is bordered on one or more sides by outlet cells 110 and vice versa, i.e., they are arranged in a checkerboard pattern. The inlet and outlet cells 108, 110 may have a square cross-section as shown in FIG. 1 or may have other cell geometry, e.g., rectangular, circular, triangular or hexagonal. Diesel particulate filters are typically made of ceramic materials such as cordierite, aluminum titanate or silicon carbide. For diesel particulate filtration, honeycomb filters having cellular densities between about 10 and 300 cells/in² (about 1.5 to 46.5 cells/cm²), more typically between about 100 and 200 cells/in² (about 15.5 to 31 cells/cm²), are considered useful in providing sufficient wall surface area in a compact structure. Wall thicknesses can vary upwards from the minimum dimension of about 0.005 in. (about 0.13 mm), but are generally less than about 0.060 in. (1.5 mm) to minimize filter volume. A range of between about 0.010 and 0.030 in (about 0.25 and 0.76 mm), e.g., 0.019 in., is most often selected for ceramic materials such as cordierite, aluminum titanate and silicon carbide at the preferred cellular densities.

Prior art methods for plugging cells of a honeycomb substrate include forming a mask having openings and applying the mask to an end face of the honeycomb substrate, after which filler material is injected into desired cells of the honeycomb substrate through the openings in the mask. There are various methods for forming masks for plugging of cells of a honeycomb substrate. For example, U.S. Pat. No. 4,557,773 (Bonzo) describes an automated method for forming a mask which involves adhering a thin transparent polymer film to an end face of a honeycomb substrate and using a camera to scan the film and generate signals indicative of the location of the cells beneath the film. The cell location signals are used to position a tool to create openings through the film. The method is repeated for the other end face of the honeycomb substrate. For a substrate having a high cell density, a laser is used to create the openings in the film. This process involves calculating which regions of the film are to be removed, and using the laser to vaporize the film from these regions.

However, there are challenges to using a laser to form openings in the film. One challenge is that a honeycomb substrate can have a large number of cells, each of which has to be plugged on one end of the substrate. Therefore, it can take a significant amount of time for the laser to form all the openings in the mask. Because the system uses measurements on the image of the substrate to calculate the regions of the films to be evaporated by the laser, it is desirable to maintain accurate registration between the camera and the laser. Further, the camera used to image the end face of the substrate is affected by distortion in the optical components. It is, therefore, desirable to compensate for these distortions in order to make accurate determination of cell locations from the image. This is especially true for large diameter substrates. Additionally, the openings in the film must be precisely aligned with cells of the honeycomb substrate to allow the filler plug material to be properly injected into the cells. This requires that the orientation of the substrate relative to the laser be very accurately known, so that the appropriate commands for creating openings in the film can be generated. Further, in the processes of cutting the mask with the laser, it was discovered that pieces/parts of the mask film being cut may be cut loose and fall into the cell, or otherwise be only partially detached.

From the foregoing, it is apparent that there continues to be a desire for an improved method and system for forming a mask for plugging cells of a honeycomb structure.

### SUMMARY OF THE INVENTION

In one aspect, the invention relates to a method of making a mask for plugging cells in a honeycomb substrate. The method comprises capturing a first image, using a first camera, of a first end of the honeycomb substrate through a first transparent or translucent film applied to the first end, and then forming a first pattern of openings in the film using a first laser. In particular, a working distance, WD_{C}, of the first camera while capturing the first image is substantially the same as a working distance, WD_{L}, of the first laser while forming the first pattern of openings. Most preferably, the ratio of WD_{C}/ WD_{L} is between 0.8 and 1.2. Accordingly, sensitivity due to misalignment of the substrate is reduced.

In another aspect, the invention relates to a system for making a mask for plugging a honeycomb substrate. The system comprising a first laser positioned in opposing relation to a first end of the honeycomb substrate which has transparent or translucent film applied thereon; and a first camera assembly positioned in opposing relation to the first end to image the first end through the film. The working distance, WD_{C}, of the first camera assembly is substantially the same as the working distance, WD_{L}, of the first laser.

In yet another aspect, the invention is an apparatus for manufacturing a mask on a honeycomb substrate comprising a laser adapted to form openings in a film applied to the honeycomb substrate; and an optical system wherein either the optical system or the honeycomb substrate is moved between first and second operating positions. An image of a cell structure of the honeycomb substrate through the film is obtained at the first operating position, and at the second operating position a path of the laser is unobstructed by the optical system. In a first embodiment, the optical system (camera and mirror or just the mirror) moves between the first and second operating positions. In a second embodiment, the substrate is moved between the first and second operating positions while the camera remains stationary.

In still a further aspect, the invention is a system for manufacturing masks for plugging a honeycomb substrate. The system comprises a mount supporting a honeycomb substrate having a first film applied on a first end and a second film applied to a second end. A first camera assembly is positioned in opposing relation to the first end to image the first end through the first film, and a first laser is positioned in opposing relation to the first end to form openings in the first film corresponding to a first set of cell channels. A second camera assembly is positioned in opposing relation to the second end to image the second end through the second film and a second laser is positioned in opposing relation to the second end to form openings in the second film corresponding to a second set of cell channels. The masks are formed on the first and second ends without having to reposition the substrate in the holder.

Other features and advantages of the invention will be apparent from the following description and the appended claims.

### BRIEF DESCRIPTION OF THE DRAWINGS

FIG. 1 is a schematic of a prior-art wall-flow particulate filter.

FIG. 2A is a top view of a mask for plugging cells of a honeycomb substrate.

FIGS. 2B-2D illustrate partial frontal views of different openings in a film.

FIG. 3A illustrates a system for manufacturing masks for plugging cells of a honeycomb substrate on both ends of the substrate.

FIG. 3B illustrates a system for manufacturing a mask for plugging cells of a honeycomb substrate.

FIG. 4 is a perspective view of a honeycomb substrate.

FIG. 5 illustrates injection of filler plug material through the mask and into cells of the honeycomb substrate.

FIG. 6 illustrates another system embodiment of the invention for manufacturing a mask for plugging cells of a honeycomb substrate.

FIG. 7 is a view illustrating the working distance of the a laser utilized in the systems of FIGS. 3A, 3B and 6.

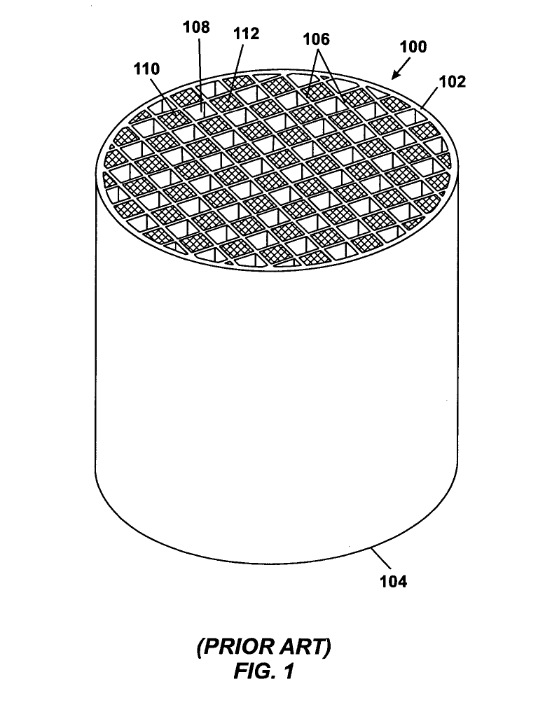

### DETAILED DESCRIPTION OF THE INVENTION

The invention will now be described in detail with reference to a few preferred embodiments, as illustrated in accompanying drawings. In the following description, numerous specific details are set forth in order to provide a thorough understanding of the invention. However, it will be apparent to one skilled in the art that the invention may be practiced without some or all of these specific details. In other instances, well-known features and/or process steps have not been described in detail in order to not unnecessarily obscure the invention. The features and advantages of the invention may be better understood with reference to the drawings and discussions that follow.

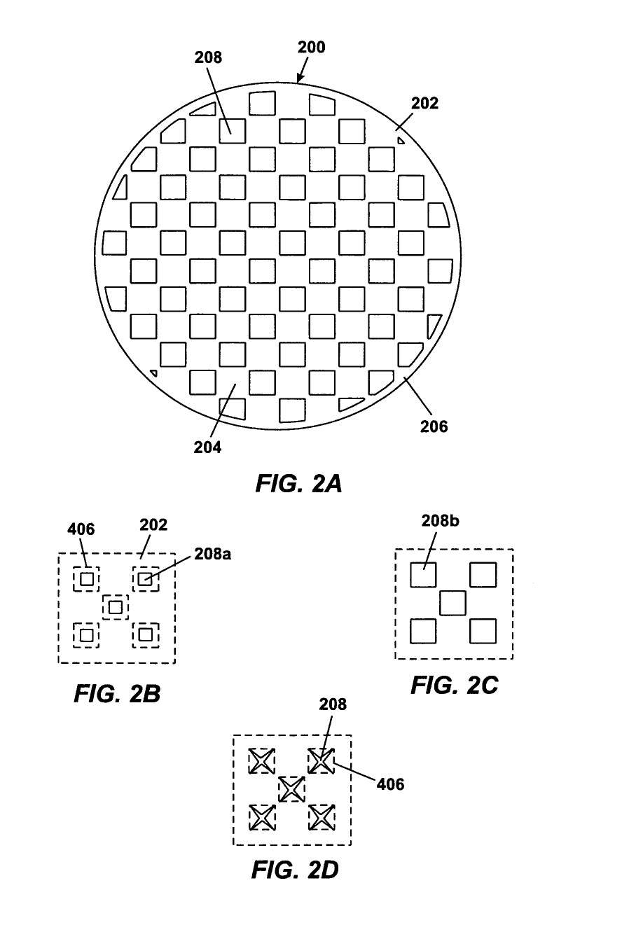

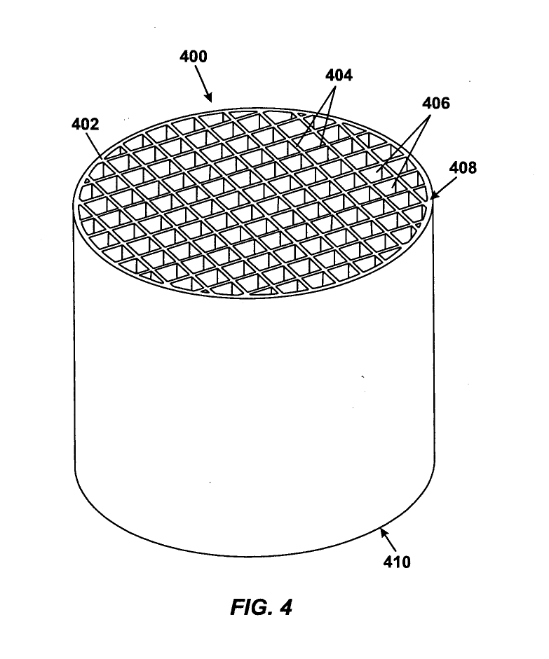

FIG. 2A illustrates a mask 200 for selectively plugging cells of a honeycomb substrate (not shown for clarity). The mask 200 is manufactured from a thin film 200 of transparent or translucent material and comprises a cell mask region 204 bordered by a skin mask region 206. When the mask 200 is placed on a honeycomb substrate (FIG. 4), the cell mask region 204 overlays the cells and cell walls of the honeycomb substrate, and the skin mask region 206 overlays (and may extend beyond) the skin of the honeycomb substrate 400. The cell mask region 204 includes a plurality of openings 208 formed therein, through which filler plug material (not shown) can be injected into cells of the honeycomb substrate to form plugs. The openings 208 coincide with the cells of the honeycomb substrate into which filler material will be injected. The shape of the openings 208 may or may not be the same as the shape of the cells of the honeycomb substrate. In general, the shape of the openings 208 should be selected such that the cells can be filled evenly with the filler plug material. In FIG. 2A, the openings 208 have a square shape to match the shape of the honeycomb substrate cells. The square openings 208 may optionally have filleted or chamfered corners and the size of the openings generally approximates the size of the cells. The film needs to be transparent or translucent such that the cell structure may be imaged through it. The transparent or translucent film 200 may be made of a wide variety of materials, for example, a polymer (e.g., polyester, polyolefin, polyethylene, polypropylene, polyvinyl chloride, PET, or the like) or an elastomer (e.g., silicone). The film 200 preferably includes an adhesive backing, such as an acrylic adhesive. Additionally, the film 200 is of a thickness such that it can be vaporized/ablated by a laser. Films 200 having an overall thickness between 0.001 inch and 0.005 inch (0.0254 to 0.127 mm) are preferred.

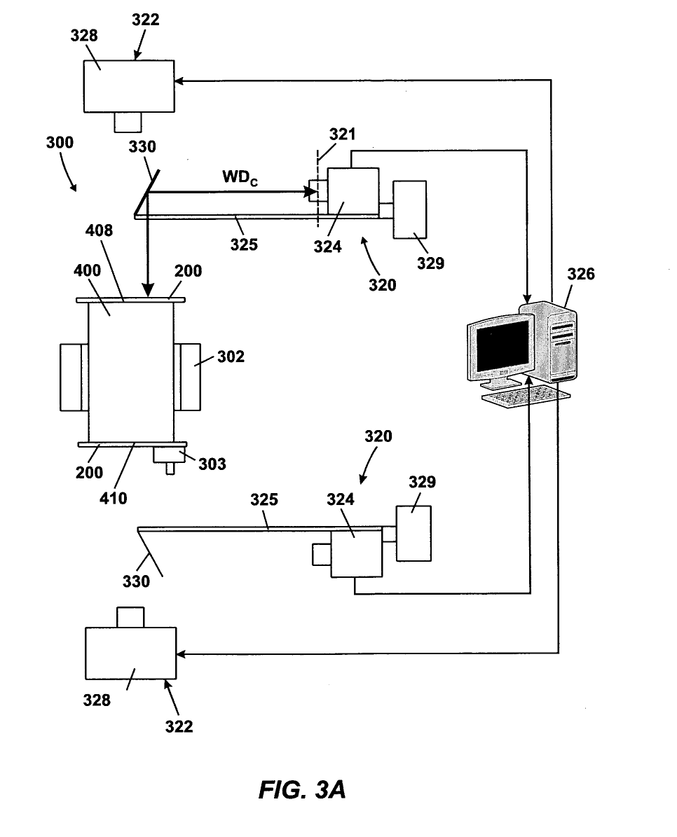

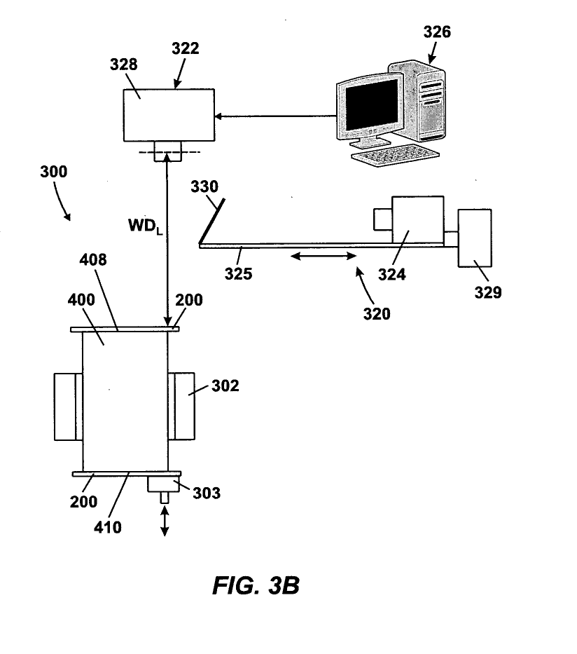

FIG. 3A illustrates a system 300 for manufacturing the mask (200 in FIG. 2A). The system 300 includes a honeycomb substrate holder 302. In the example shown in FIG. 3A, the holder 302 is a v-block, having a v-shaped indentation into which the substrate rests. However, the support is not limited to use of a v-block and any other suitable positioning support fixture may be employed. For example, an inflatable bladder may be used to secure the honeycomb substrate 400, or a support having a contour closely conforming to the shape of the substrate. Clamps or other suitable mechanisms may also be include in the holder 302 to secure the honeycomb body 400. In short, the substrate needs to be held stationary during the mask forming process. The holder preferably includes a stop 303 which is used to set the position of the substrate 400 relative to the laser 322 and optical system 320 such that the substrate is always at a predetermined distance away. The stop is preferably removable/repositionable such that it does not obstruct the laser 322 during the cutting or the view of the optical system 320 during imaging.

FIG. 4 shows a perspective view of a typical honeycomb substrate 400 to be plugged. The honeycomb substrate 400 is columnar and has a cross-sectional shape defined by its skin 402. The skin 402 profile is typically circular, rectangular, or elliptical, but the invention is not limited to any particular skin profile. The honeycomb substrate 400 has an array of interconnecting porous walls 404 intersecting with the skin 402. The porous walls 404 define a grid of channels or cells 406, which extend longitudinally along the length of the honeycomb substrate 400, between end faces 408, 410 of the honeycomb substrate 400. The cross-section of the channels or cells 406 may be square, rectangular, round, octagonal, hexagonal, triangular or may have other shapes. Typically, the honeycomb substrate 400 is made by extrusion. Further, the extrusion material is typically a ceramic-forming material, such as cordierite, aluminum titanate, or silicon carbide forming material, but could also be glass, glass-ceramic, plastic, or metal. The thickness and porosity of the porous walls 404 are such that the structural integrity of the honeycomb substrate 400 is not compromised. For diesel exhaust filtration, the porous walls 404, after firing, may incorporate pores having mean pore diameters in the range of 1 to 60 μm, more preferably in a range from 10 to 30 μm, and wall thickness and cell geometries as described above.

Returning to FIG. 3A, the honeycomb substrate 400 is held stationary in the holder 302 while masks 200 for the end faces 408, 410 of the honeycomb substrate 400 are formed from the film adhered to the end faces. In the following discussion, a method, apparatus and system of forming the mask for the end face 408 will be discussed. This same method and system can be used to form a mask for the end face 410. Forming masks for the end faces 408, 410 simultaneously reduces the time it takes to form the masks and thereby plug cells in the honeycomb substrate 400. Further, it also increases the uniformity and eliminates any need to form identifiers on the ends or otherwise determine the orientation of the cells to be filled on the other end. In particular, any repositioning in the holder was found to be detrimental to the quality of the mask.

To form a mask for the end face 408 of the honeycomb substrate, a film 200 (which is cut to a desired outside dimension) for making a mask (FIG. 2A) is adhered on the end face 408. In one example, the film 200 is adhered to the end face and extends beyond the periphery of the honeycomb (as shown). The adherence of the film 200 is provided by including a tacky adhesive backing (described beforehand) on the film, or by applying a layer of adhesive between the transparent film 200 and the end face 408 of the honeycomb substrate 400. If the mask is to be formed for the end face 410, the film 200 would also be applied to end face 410. In a preferred system, both end faces include films 200 adhered thereto and they are formed substantially simultaneously, or at least without having to reposition the substrate 400 in the holder 302.

The system 300 further includes an optical system 320 for imaging the end face 408 of the honeycomb substrate 400 through the transparent or translucent film 200. The system 300 also includes a laser system 322 for creating (burning) openings in the film 200. A suitable laser is a CO₂ laser with a maximum power of about 100 watts. Most preferably, the laser power is adjustable, with preferred adjustment between 0 and 100 watts, to allow the power to be adjusted to match the power needed for cutting the openings in the film 200. The openings are the holes through which filler plug material may be injected into cells of the honeycomb substrate 400. The optical system 320 includes a camera 324 that scans through the films 200 and generates images indicative of the location of cells and/or porous walls in the end faces 408, 410 of the honeycomb substrate 400. A suitable camera is an area camera with sufficient resolution to enable identification of the cell locations. A Redlake, ES11000 camera with 4008×2672 pixels was found to be suitable. The images generated by the camera 324 are transmitted to an analyzer 326, preferably a computer, which translates the images into laser control commands to control the path of the laser beam emitted from the laser system 322. Preferably, the optical system 320 includes both a mirror 330 and a camera 324. The mirror 330 allows the camera 324 to be offset from the substrate 400 and yet still have substantially the same working length as the laser.

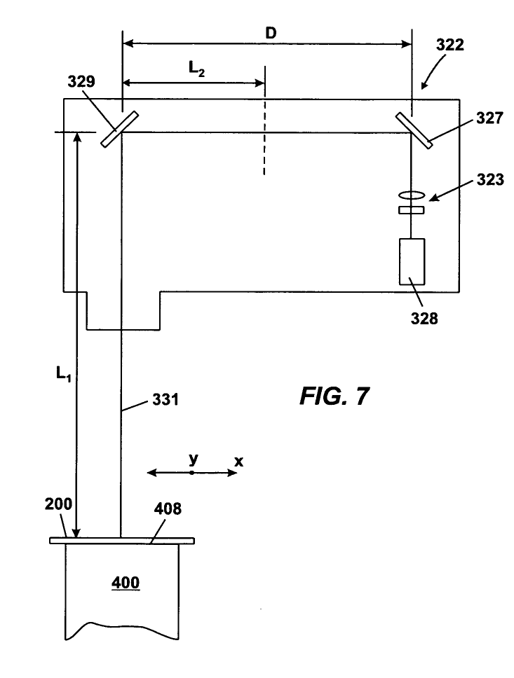

The laser system 322, as best shown in FIG. 7, includes a laser source 328, optics 323 and moveable mirrors 327, 329. Precision actuators (not shown) are coupled to the mirrors 327, 329 and are operable to move the laser beam 331 in the X-Y coordinate system (in a plane parallel to the face 408 of the honeycomb substrate 400. In particular, an actuator attached to mirror 327 rotates the mirror to control movement of the laser beam 331 in the X-direction (along the directional arrow shown). Similarly, another actuator attached to mirror 328 rotates the mirror to control movement of the laser beam 331 in the Y-direction (into and out of the paper). A suitable actuator is a GSI Lumonics Galvanometer, which uses two rotating mirrors to control the position of the laser beam 331. The laser control commands generated by the analyzer 326 are used to control the precision actuators to position the mirrors 327, 329 and thus the laser beam 331 emitted from the laser source 328 in the X-Y coordinate system to create openings through the transparent film 200 at predetermined cell locations. To form the mask for the end faces 408, 410, an optical system 320 and laser system 322 would also be located in opposing relation to the end faces 408, 410 in substantially the same manner as for the first end.

Again referring to FIG. 3A, the optical system 320 (including camera 324 and mirror 330), in this embodiment, is preferably positioned at a first operational position (as shown) between the laser source 328 and the end faces 408, 410 when capturing the image of the cell locations in the end faces 408, 410. The optical system 320 is preferably moveable from the first operational position (as shown) to a second retracted operational position (see FIG. 3B), in that the system 320 can be moved out of the trajectory of the laser 328 such that the laser is unobstructed during the opening forming operation. In other words, the mirror, and preferably the mirror and camera may be moved out of the way of the laser during the opening forming operation. Preferably the movement between the operating positions is accomplished by an actuator 329 coupled to a frame 325 upon which the camera 324 and mirror 330 are mounted. Optionally, the actuator 329 may be coupled only to the mirror 330 and, thus, the moving mirror constitutes the moveable optical system, in that the mirror 330 may be moved, as needed, relative to the end face 408, while the camera 324 remains stationary. After capturing the image of the end faces 408, 410, in the first operational position (shown in FIG. 3A), the camera 324 and mirror 330 are moved aside to the second operational position, as shown in FIG. 3B, to allow the laser source 328 to create openings in the transparent film 200 on the end face 408. In this manner, cutting of the mask for the honeycomb substrate 400 can be accomplished without having to reposition the honeycomb substrate 400 in the holder.

In addition, the optical system 320 is such that the camera 324 views the end face 408 from the same working distance and, therefore, the same viewing geometry as the laser source 328. This is achieved, for example, as follows: the optical system 320 includes a mirror 330 positioned at an angle, typically approximately 45 degrees, to the end face 408 and movable with the camera 324; both being mounted on the rigid frame 325. The camera 324 focuses on the mirror 330 and images the end face 408 by capturing reflections of the end face 408 from the mirror 330. The working distance, WD_{C}, of the camera 324 while imaging the end face 408 through the mirror 330 is substantially the same as the working distance, WD_{L}, of the laser source 328 (See FIG. 3B) while forming openings in the transparent film 200 on the end face 408. Herein, the term “working distance”of the camera, WD_{C}, is the distance between the face of the film 200 and the principal plane 321 of the lens system of the camera 324. The working distance, WD_{L}, of the laser is defined as the distance between the face of the film 200 and the center of the control system of the laser. In particular, referring to FIG. 7, the working distance, WD_{L}, is given by the following relationship:
WD_{L}=L₁+L₂=L₁+(D/2)
where
L₁ is the distance between the face of the film 200 and the mirror 329 measured along the laser beam,
L₂ is half the distance between the mirror 329 and 327 measured along the laser beam, and
D is the distance between the mirrors 329 and 327 measured along the laser beam.

Having the working distances be substantially equalized provides the advantages of matching the optical geometry of the camera to the optical geometry of the laser. This makes the translation of measured cell locations in the part image to laser coordinates more robust. In particular, it minimizes errors due to any slight substrate misalignment in the holder. Most preferably, the ratio of the WD_{C}/WD_{L} is between 0.8 and 1.2; more preferably between 0.9 and 1.1.

The analyzer 326 uses the image captured by the camera 324 to generate control commands for the laser source 328 which than moves the laser beam 331 (FIG. 7) in the X-Y coordinates. The analyzer 326 uses a calibration map to relate pixel locations on the image from the camera 324 to physical locations of the laser beam 331 of the laser source 328 (at the target location). One method of generating the calibration map includes generating a calibration grid using, for example, a suitable CAD program. The calibration grid is composed of a series of objects at predefined locations, for example small squares. The calibration grid is next translated into laser control commands or coordinates. A target is placed at the same location the honeycomb substrate 400 would be placed relative to the laser source 328. Typically, this occurs before the honeycomb substrate 400 is placed in the holder 302, at the start of a production run, for example. The control commands generated using the calibration grid are used to control the laser source 328 to cut the calibration grid on the target. The target is typically a flat plate that can be visibly marked by the laser beam 331 from the laser source 328. In one example, the target is a white foam board coated with a black coating. The power of the laser source is adjusted to burn off the black coating on the foam board at selected locations, exposing the white, underlying foam. This creates a high contrast mark on the foam board that can be easily imaged and analyzed to create the map. Calibration between the pixel space of the image and the X-Y orientation of the laser are recorded as the calibration map thereby correcting for distortion, etc. in the viewing field.

In operation, after burning the geometric calibration grid pattern on the target, the camera 324 and mirror 330 are indexed into the honeycomb substrate viewing position (the first operational position) and an image of the calibration grid on the target is captured. The image of the calibration grid is analyzed, and the pixel locations of each of the grid features in the image are calculated (for example, the grid features may constitute a 28×28 grid of small squares). The pixel locations of each feature (square) are recorded along with the laser command coordinates of the associated feature in the calibration grid. These recorded physical and pixel locations form the calibration map. In operation, an interpolation routine is used to translate the measured pixel locations of the cells back into associated laser command coordinates. Because the calibration method relates measured pixel locations in the captured image to actual laser control commands, it automatically compensates for optical distortions, alignments, and coordinate transformations between the optical system 320 and the laser system 322. After generating the calibration map, it is possible to visually verify the accuracy of the calibration map by imaging the calibration grid formed on the target, locating the respective grid features, and calculating the commands necessary to cut a secondary feature at each of these grid feature locations. This set of commands can be sent to the laser source to perform a secondary cut, and the alignment of the original calibration features with the secondary cut features gives a direct visual measurement and indicator of the accuracy of the calibration.

When creating openings in the transparent film 200, the laser source 328 is typically focused, through optics, to a beam having a spot size that is substantially smaller in size than the opening being cut in the transparent film 200. If the laser source 328 is commanded to simply cut around the perimeter of a cell, i.e., adjacent to the walls, in the end face 408, a part of the transparent film 200 over the center of the cell may sometimes fall into the cell, or otherwise be left hanging from the mask. The goal, of course, is to fully ablate the material removed so that no portion of the material inside the perimeter remains. The ability not to fully ablate can be avoided by defocusing the laser source 328 so that it cuts a larger opening. However, this approach would reduce the targeting accuracy of the laser and would require that the laser setup be changed for different cell densities. FIGS. 2A and 2B illustrate an alternate approach for making openings 208 (FIG. 2A) in the film 200. This approach involves first cutting a small dimensioned polygon 208a (preferably a square) at the center of the cell 406 (perimeter indicated by dotted line) thereby vaporizing (ablating) the film 200 at or near the center of the cell (FIG. 2B). This is followed by cutting a larger dimensioned polygon 208b around the smaller one in order to cut out and ablate the remaining film from the cell (FIG. 2C). Preferably, the laser is shut down while transitioning to the larger dimensioned polygon. Thus, an opening is formed which approximates the cross-sectional area of the cell 406 and wherein all the material inside thereof is ablated.

Another approach is to form openings in the film 200 that do not trace the perimeter of the cell 406, but allow the cell to be filled uniformly with filler material. For example, as illustrated in FIG. 2D, the opening 208 could be lines extending diagonally between corners of the cell. For a square or rectangular cell, the opening would then have an X or cross shape. In this case, there is no risk of film falling into the cell. Further, it takes fewer laser strokes to cut an X shape than it takes to cut a square shape or nested polygon shapes as described above. Also, since the X shape extends to the corners of the cells, it assists in channeling filler material to the corners of the cell, thereby improving the integrity of the plug formed in the cell.

As shown in FIG. 4, the cells 406 of the honeycomb substrate 400 are typically oriented in an orthogonal array of rows and columns, and each channel has a specific shape. Typically, this shape is square, but it can have other shapes as well as previously mentioned, e.g., rectangular, triangular, hexagonal, and so forth. If it is desirable to create a plugging mask with openings that match the shape of the underlying cells, it is necessary to know the orientation of the cells with respect to the laser X-Y axis coordinate system so that appropriate cut commands can be calculated to create an opening that has the same orientation as the cell. Knowing the rotational orientation of the substrate 400 relative to the X-Y coordinates of the laser also simplifies assignment of the cells into a predefined pattern and registering of the masks on the two end faces of the substrate so that alternative cells are plugged on each side of the substrate.

To do this, a region of the image captured by the camera (324 in FIG. 3A) is analyzed to determine the location of two adjacent cells in the honeycomb substrate 400. The Euclidean distance between these two locations provides a measure of the cell spacing, which allows the analyzer (326 in FIG. 3A) to process images of substrates with different cell densities without previous knowledge of the cell spacing. The relative angle between the two adjacent cells provides information about the rotational orientation of the honeycomb substrate 400 relative to the camera and laser. The appropriate cut commands for the laser to create the opening in the film 200 are then rotated around the center location of each cell by this measured angle in order to align the shape of the cut entity with the rotated part.

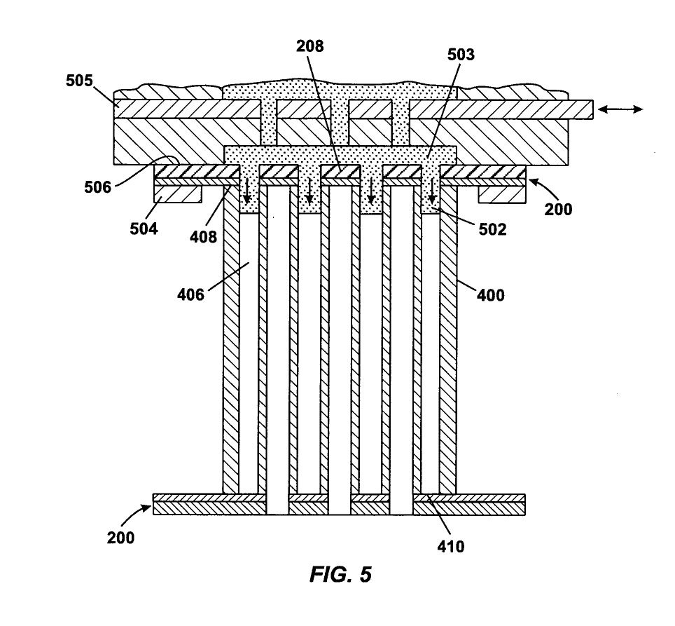

FIG. 5 shows a injecting filler plug material 502 from a reservoir 503 into selected cells 406 in the end face 408 of the honeycomb substrate 400 through the laser-cut openings in the mask 200 to form the plugs. The filler material 502 is preferably any flowable plugging material such as mixture of a ceramic raw material with a binder and a plasticizer, for example. U.S. patent application Ser. No. 11/186,466 entitled “Ceramic Wall Flow Filter Manufacture”filed Jul. 20, 2005 describes several useful ceramic-forming plugging materials. The footprint of the mask 200 may be the same as the footprint of the end face 408 of the honeycomb substrate 400. Alternatively, the mask 200 may be larger than the end face 408 of the honeycomb substrate 400 so that it extends beyond the periphery of the honeycomb substrate 400 as taught in application Ser. No. 10/990,109 entitled “Mask For Plugging Particulate Filter Cells” filed Nov. 15, 2004, for example. Preferably, a frame or claming member 504 clamps the mask 200 against a surface 506 surrounding the reservoir 503 to seal the mask to the reservoir 503. Material is injected and its flow is controlled by a flow control device 505. The plugging apparatus may be as taught in, for example, U.S. Pat. No. 4,557,773 (Bonzo) or in U.S. patent application Ser. No. ______ entitled “Plugging Methods and Apparatus For Particulate Filters”filed contemporaneously with the present application. To save time in forming plugs in the honeycomb substrate 400, filler material 502 can be injected simultaneously into the end faces 408, 410 of the honeycomb substrate 400.

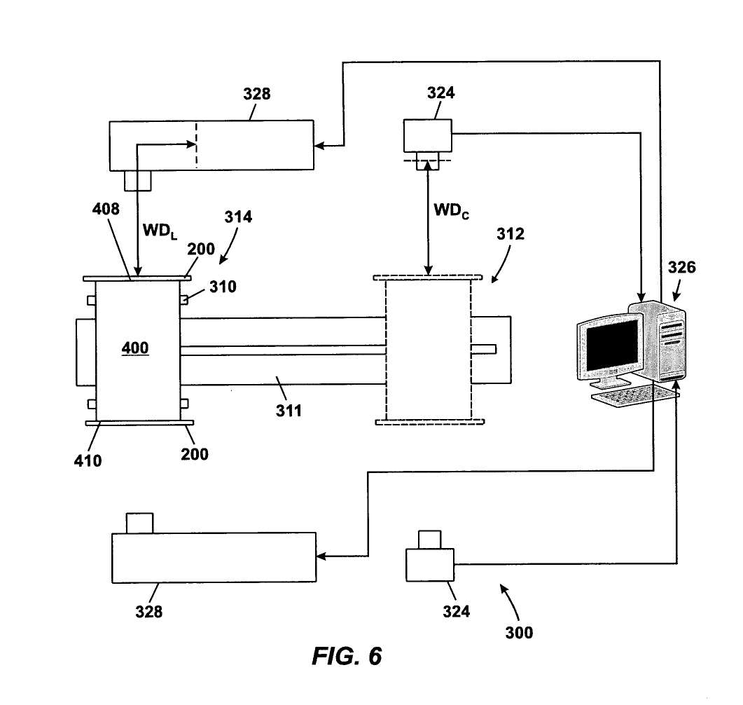

An alternative apparatus 300 according to embodiments of the invention is shown and described with reference to FIG. 6. In this embodiment, the apparatus 300 includes an optical system comprising a camera 324, and a laser 328 as in the previous embodiment, except that in this embodiment, the optical system, i.e., the camera 324 is stationary. The substrate 400 to be masked (having film 200 thereon) is mounted in a moveable holder 310 which moves from a first location 312 positioning the end 408, 410 in front of the camera 324, to a second location 314 in front of the laser 328. The holder 310 is preferably mounted on a track 311 and moves along a linear path from the first 312 to the second 314 operating position. The track 311 preferably includes positive stops at either end such that precise location at the positions 312, 314 is accomplished. In operation, the substrate 400 is placed in the holder 310 at the first position 312 and an image of both end faces are obtained by the camera 324 and provided to the analyzer 326. The substrate 400 is then moved to the second position 314 adjacent to the laser system 328 and openings are burned in the films to produce the masks 200. The analyzer 326 correlates the images taken of each end face 408, 410 to ensure that the openings formed in the first end 408 are aligned with different cells than the openings formed in the second end 410. In this embodiment, the working distance of the camera, WD_{C}, is also set to be substantially equal to the working distance of the laser, WD_{L}. The definitions of working distances are the same as in the previous embodiments. It should be recognized that this apparatus enables cutting of the openings at the second operating position wherein the path of the laser beam is unobstructed by the optical system.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of manufacturing a mask for plugging cells in a honeycomb substrate, comprising:
capturing a first image, using a first camera, of a first end of the honeycomb substrate through a first transparent or translucent film applied to the first end of the honeycomb substrate; and
forming a first pattern of openings in the first transparent or translucent film using a laser beam of a first laser wherein a working distance, WD_{C}, of the first camera while capturing the first image is substantially the same as a working distance, WD_{L}, of the first laser while forming the first pattern of openings.

2. The method of claim 1 wherein the step of capturing includes positioning a first mirror at an angle to the first end and capturing a reflected image of the first end.

3. The method of claim 2 wherein the angle is approximately 45 degrees.

4. The method of claim 1, further comprising a step of generating control commands to cause the laser beam to move along a directional path such that openings in the first pattern of openings substantially coincide with edges of cells in the first end.

5. The method of claim 4 wherein the step of generating control commands comprises determining a relative rotational orientation of cells at the first end relative to an axis of the first camera or first laser.

6. The method of claim 5 wherein determining orientation of cells comprises determining a relative angle between two cells in the first image and determining orientation of cells from the relative angle.

7. The method of claim 4 wherein the step of generating control commands comprises determining a spacing between cells at the first end.

8. The method of claim 1, further comprising generating a calibration map for relating pixel locations in the first image to physical positions of the first laser.

9. The method of claim 8 wherein generating a calibration map comprises generating a grid using the first laser and then capturing an image of the grid.

10. The method of claim 9, further comprising placing a target at the fixed location and executing control commands to form the grid on the target.

11. The method of claim 10, further comprising capturing an image of the grid formed on the target using the first camera and analyzing the image of the grid to determine the relation between pixel locations in the image and physical locations of the laser beam during forming of the grid on the target.

12. The method of claim 1, further comprising generating control commands such that cutting of the first pattern of openings comprises first cutting a small opening at a hole position and then cutting a larger opening around the small opening.

13. The method of claim 1, further comprising generating control commands such that cutting of the first pattern of openings comprises cutting diagonal lines, wherein the lines extend into corners of cells at the first end.

14. The method of claim 1, further comprising the steps of:
capturing a second image, using a second camera, of a second end of the honeycomb substrate through a second transparent or translucent film applied to the second end of the honeycomb substrate; and
forming a second pattern of openings in the second transparent or translucent film using a second laser wherein a working distance, WD_{C}, of the second camera while capturing the second image is substantially the same as a working distance, WD_{L}, of the second laser while forming the second pattern of openings wherein the steps of capturing the second image and forming the second pattern occurs without repositioning the substrate in a holder.

15. The method of claim 14 wherein the steps of capturing and forming occur substantially simultaneously for the first and second ends.

16. A system for making a mask for plugging a honeycomb substrate, comprising:
a first laser positioned in opposing relation to a first end of the honeycomb substrate having transparent or translucent film applied thereon; and
a first camera assembly positioned in opposing relation to the first end to image the first end through the film wherein a working distance, WD_{C}, of the first camera assembly is substantially the same as a working distance, WD_{L}, of the first laser.

17. The system of claim 16, further comprising a second laser and a second camera assembly positioned in opposing relation to a second end of the honeycomb substrate.

18. The system of claim 16 wherein a ratio of WD_{C}/WD_{L} is between 0.8 and 1.2.

19. The system of claim 16 further comprising an analyzer which translates pixel locations of images captured by the first camera assembly into physical positions of the first laser.

20. An apparatus for manufacturing a mask on a honeycomb substrate, comprising:
a laser adapted to form openings in a film applied to the honeycomb substrate; and
an optical system including a camera
wherein either the optical system or the honeycomb substrate is moved between a first operating position and a second operating position, and an image of a cell structure of the honeycomb substrate through the film is obtained at the first operating position, and at the second operating position a path of the laser is unobstructed by the optical system while forming the first pattern of openings.

21. An apparatus of claim 20 wherein the optical system comprises a camera and a mirror and wherein both the camera and the mirror are moveable between the first and second operating positions.

22. An apparatus of claim 20 wherein the optical system comprises a stationary camera and wherein the substrate is mounted in a holder and is moveable between the first and second operating positions along a track.

23. An apparatus of claim 20 wherein a working distance, WD_{C}, of the camera while capturing the image is substantially the same as a working distance, WD_{L}, of the laser while forming the openings.

24. A system for manufacturing masks for plugging a honeycomb substrate, comprising:
a mount supporting a honeycomb substrate, said substrate having a first film applied on a first end and a second film applied to a second end opposite the first end;
a first camera assembly positioned in opposing relation to the first end to image the first end through the first film;
a first laser positioned in opposing relation to the first end to form openings in the first film corresponding to a first set of cell channels;
a second camera assembly positioned in opposing relation to the second end to image the second end through the second film; and
a second laser positioned in opposing relation to the second end to form openings in the second film corresponding to a second set of cell channels, different from the first set wherein the masks may be formed on the first and second ends without having to reposition the substrate.

25. The system of claim 24 wherein a working distance, WD_{C}, of the first camera assembly is substantially the same as a working distance, WD_{L}, of the first laser.

26. The system of claim 24 wherein a working distance, WD_{C}, of the second camera assembly is substantially the same as a working distance, WD_{L}, of the second laser.
